(19) United States
(12) Patent Application Publication
(10) Pub. No.: US 2012/0274156 A1
(43) Pub. Date: Nov. 1, 2012

(54) ELECTRIC MACHINE MODULE INSULATION SYSTEM AND METHOD

(76) Inventors: Bradley D. Chamberlin, Pendleton, IN (US); Richard E. Trammell, Noblevllle, IN (US); Mark Stephenson, FaIrland, IN (US)

(21) Appl. No.: 13/460,381

(22) Filed: Apr. 30, 2012

Related U.S. Application Data
(60) Provisional application No. 61/481,000, filed on Apr. 29, 2011.

(51) Int. Cl. H02K 3/38; H02K 3/30; H02K 5/20

(52) U.S. Cl. 310/43; 310/208; 310/58

(57) ABSTRACT

Embodiments of the invention provide an electric machine module including a housing. The housing can include a machine cavity. In some embodiments, an electric machine can be at least partially positioned within the machine cavity and can include a stator assembly. The stator assembly includes a stator core with slots, a weld end, and an insertion end. In some embodiments, conductors can be positioned in the slots so that portions of the conductors extend from the weld end and the insertion end. An insulation member including recesses can be coupled to at least a portion of the conductors that extend from the weld end of the stator assembly.

### RELATED APPLICATIONS

This application claims priority under 35 U.S.C. §119 to U.S. Provisional Patent Application No. 61/481,000 filed on Apr. 29, 2011, the entire contents of which is incorporated herein by reference.

### BACKGROUND

Some conventional electric machines include a rotor assembly and a stator assembly. Some stator assemblies include a plurality of axially aligned slots into which one or more conductors are inserted. After an assembly and coupling process, the conductors can be insulated to reduce the risk of injury to the conductors and short circuits that can occur between the adjacent conductors.

### SUMMARY

Some embodiments of the invention provide an electric machine module including a housing. The housing can include a machine cavity. In some embodiments, an electric machine can be at least partially positioned within the machine cavity and can include a stator assembly. In some embodiments, the stator assembly can include a stator core, a weld end, an insertion end, and a plurality of slots that can extend through the stator core from the weld end to the insertion end. In some embodiments, a plurality of conductors can be positioned within at least a portion of the plurality of slots. In some embodiments, portions of the plurality of conductors can extend from the weld end and the insertion end. In some embodiments, an insulation member comprising a plurality of recesses can be coupled to at least a portion of the conductors that extend from the weld end of the stator assembly.

### DESCRIPTION OF THE DRAWINGS

FIG. 1 is a cross-sectional view of an electric machine module according to one embodiment of the invention.

FIG. 2 is a perspective, partial cross-sectional view of an electric machine module according to one embodiment of the invention.

FIG. 3 is a perspective view of a stator assembly according to one embodiment of the invention.

FIG. 4 is front view of a stator lamination according to one embodiment of the invention.

FIG. 5 is a perspective view of a conductor according to one embodiment of the invention.

FIGS. 6A and 6B are cross-sectional views of a slot according to some embodiments of the invention.

FIG. 7A is a perspective view of an insulation member according to some embodiments of the invention.

FIG. 7B is top view of the insulation member of FIG. 7A.

FIG. 7C is a cross-sectional view of the insulation member of FIG. 7B along the line marked A-A.

FIG. 8 is a perspective view of a stator assembly according to some embodiments of the invention.

FIG. 9 is a view of a portion of the stator assembly of FIG. 8.

FIG. 10 is an expanded view of a portion of the stator assembly of FIG. 8.

FIG. 11 is a perspective view of the stator assembly of FIG. 8.

FIG. 12 is a perspective view of a portion of a stator assembly according to some embodiments of the invention

FIG. 13 is partial cross-sectional view of the stator assembly of FIG. 12.

FIG. 14 is partial cross-sectional view of conductors and an insulation member according to some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

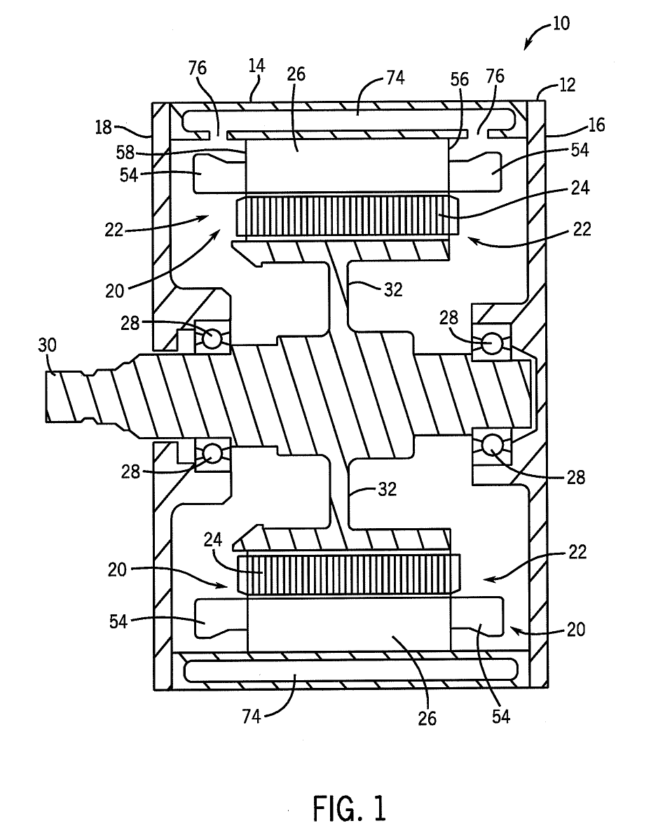

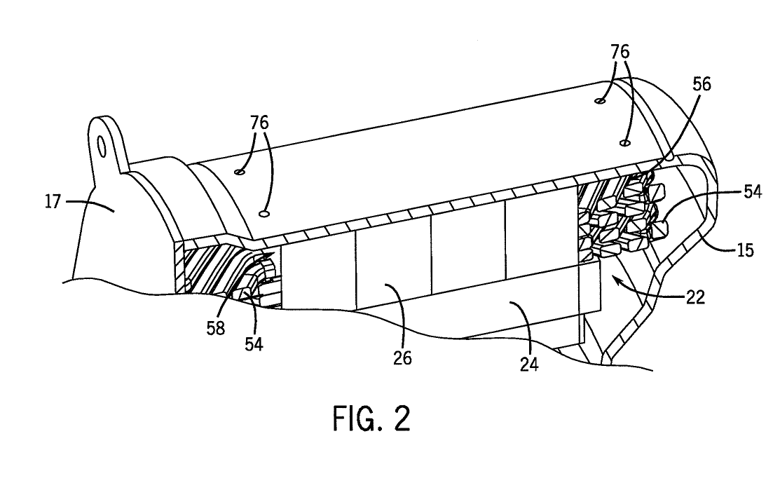

FIGS. 1 and 2 illustrate an electric machine module 10 according to one embodiment of the invention. The module 10 can include a housing 12 comprising a sleeve member 14, a first end cap 16, and a second end cap 18. An electric machine 20 can be housed within a machine cavity 22 at least partially defined by the sleeve member 14 and the end caps 16, 18. For example, the sleeve member 14 and the end caps 16, 18 can be coupled via conventional fasteners (not shown), or another suitable coupling method, to enclose at least a portion of the electric machine 20 within the machine cavity 22. In some embodiments, the housing 12 can comprise a substantially cylindrical canister 15 coupled to an end cap 17, as shown in FIG. 2. Further, in some embodiments, the housing 12 can comprise materials that can generally include thermally conductive properties, such as, but not limited to aluminum or other metals and materials capable of generally withstanding operating temperatures of the electric machine 20. In some embodiments, the housing 12 can be fabricated using different methods including casting, molding, extruding, and other similar manufacturing methods.

The electric machine 20 can include a rotor assembly 24, a stator assembly 26, and bearings 28, and can be disposed about a shaft 30. As shown in FIG. 1, the stator assembly 26 can substantially circumscribe at least a portion of the rotor assembly 24. In some embodiments, the rotor assembly 24 can also include a rotor hub 32 or can have a “hub-less” design (not shown).

In some embodiments, the electric machine 20 can be operatively coupled to the housing 12. For example, the electric machine 20 can be fit within the housing 12. In some embodiments, the electric machine 20 can be fit within the housing 12 using an interference fit, a shrink fit, other similar friction-based fits that can at least partially operatively couple the machine 20 and the housing 12. For example, in some embodiments, portions of the stator assembly 26 or other portions of the electric machine 20 can be shrunk fit into the housing 12. Further, in some embodiments, the fit can at least partially secure the stator assembly 26, and as a result, the electric machine 20, in axial, radial and circumferential directions. In some embodiments, during operation of the electric machine 20 the fit between the stator assembly 26 and the housing 12 can at least partially serve to transfer torque from the stator assembly 26 to the housing 12. In some embodiments, the fit can result in a generally greater amount of torque retained by the module 10.

The electric machine 20 can be, without limitation, an electric motor, such as a hybrid electric motor, an electric generator, or a vehicle alternator. In one embodiment, the electric machine 20 can be a High Voltage Hairpin (HVH) electric motor, an interior permanent magnet electric motor, or an induction motor for hybrid vehicle applications.

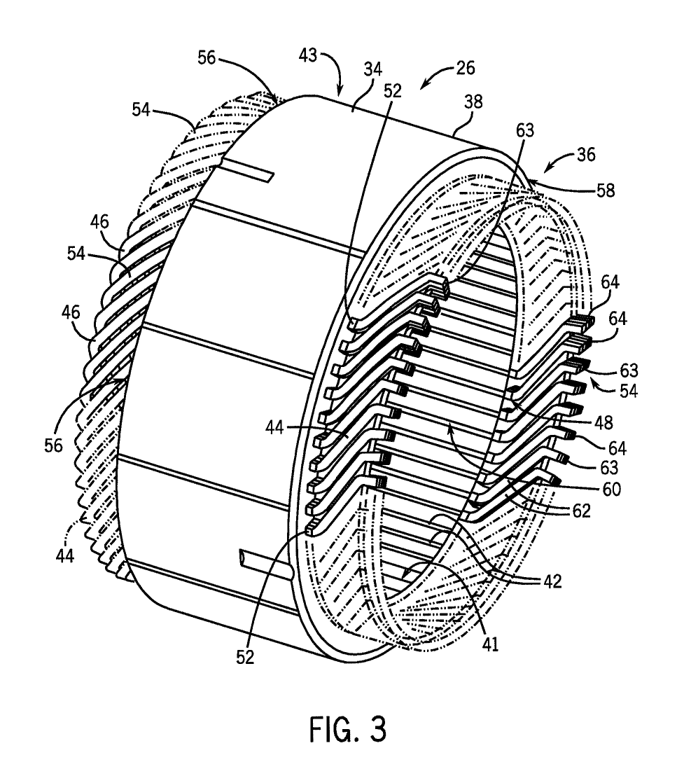

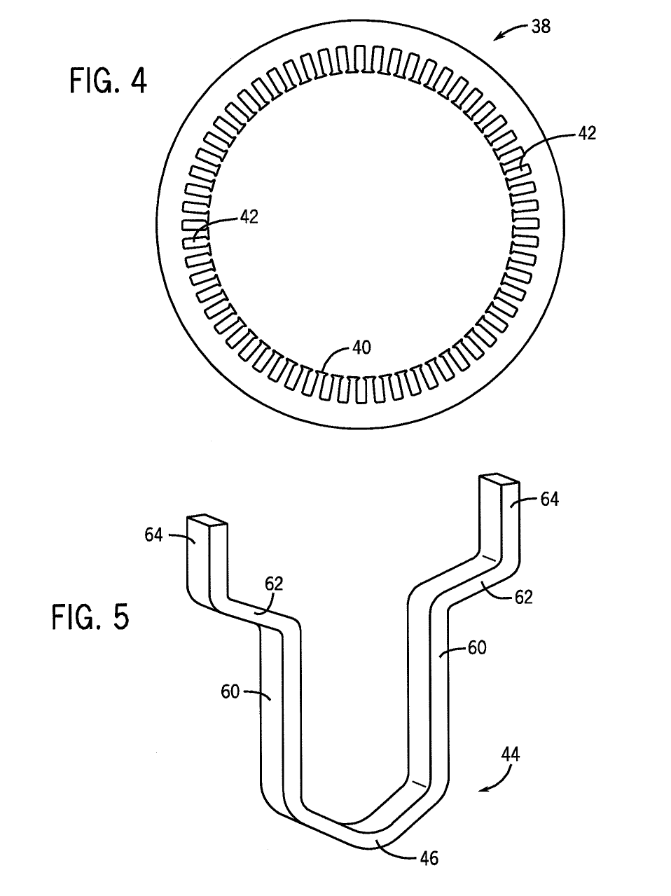

As shown in FIG. 3, in some embodiments, the stator assembly 26 can comprise a stator core 34 and a stator winding 36 at least partially disposed within a portion of the stator core 34. For example, in some embodiments, the stator core 34 can comprise a plurality of laminations 38. Referring to FIG. 4, in some embodiments, the laminations 38 can comprise a plurality of substantially radially-oriented teeth 40. In some embodiments, as shown in FIG. 3, when at least a portion of the plurality of laminations 38 are substantially assembled, the teeth 40 can substantially align to define a plurality of slots 42 that are configured and arranged to support at least a portion of the stator winding 36. As shown in FIG. 4, in some embodiments, the laminations 38 can include sixty teeth 40, and, as a result, the stator core 34 can include sixty slots 42. In other embodiments, the laminations 38 can include more or fewer teeth 40, and, accordingly, the stator core 34 can include more or fewer slots 42. Moreover, in some embodiments, the stator core 34 can comprise an inner perimeter 41 and an outer perimeter 43. For example, in some embodiments, the stator core 34 can comprise a substantially cylindrical configuration so that the inner and outer perimeters 41, 43 can comprise inner and outer diameters, respectively. However, in other embodiments, the stator core 34 can comprise other configurations (e.g., square, rectangular, elliptical, regular or irregular polygonal, etc.), and, as a result, the inner and outer perimeters 41, 43 can comprise other dimensions.

In some embodiments, the stator winding 36 can comprise a plurality of conductors 44. In some embodiments, the conductors 44 can comprise a substantially segmented configuration (e.g., a hairpin configuration), as shown in FIGS. 3 and 5. For example, in some embodiments, at least a portion of the conductors 44 can include a turn portion 46 and at least two leg portions 48. In some embodiments, the turn portion 46 can be disposed between the two leg portions 48 to substantially connect the two leg portions 48. In some embodiments, the leg portions 48 can be substantially parallel. Moreover, in some embodiments, the turn portion 46 can comprise a substantially “u-shaped” configuration, although, in some embodiments, the turn portion 46 can comprise a v-shape, a wave shape, a curved shape, and other shapes. Additionally, in some embodiments, as shown in FIG. 5, at least a portion of the conductors 44 can comprise a substantially rectangular cross section. In some embodiments, at least a portion of the conductors 44 can comprise other cross-sectional shapes, such as substantially circular, square, hemispherical, regular or irregular polygonal, etc. In some embodiments, the conductors 44 can comprise other configurations (e.g., substantially non-segmented configuration).

In some embodiments, the stator assembly 26 can comprise one or more insulating members, apparatuses, and/or other structures configured and arranged to provide mechanical, electrical, and physical insulation to some portions of the stator assembly 26. In some embodiments, at least a portion of some of the conductors 44 can comprise a first insulation 50. For example, in some embodiments, the first insulation 50 can comprise a resinous material such as an epoxy and/or an enamel that can be reversibly or irreversibly coupled to at least a portion of the conductors 44. In some embodiments, because an electrical current circulates through the conductors 44 during operation of the electric machine 20, the first insulation 50 can function, at least in part, to substantially prevent short circuits and/or grounding events between adjacent conductors 44 and/or conductors 44 and the stator core 34.

In some embodiments, the first insulation 50 can comprise a shrunk-fit structure coupled to at least some of the conductors 44 so that the first insulation 50 is retained when the conductors 44 are disposed within the stator core 28. In some embodiments, the first insulation 50 can be wrapped, wound, or otherwise disposed on, or coupled to, the conductors (e.g., via an adhesive). In some embodiments, as discussed further below, at least a portion of the conductors 44 can substantially function without some or all of the first insulation 50.

In some embodiments, the conductors 44 can be generally fabricated from a substantially linear conductor 44 that can be configured and arranged to a shape substantially similar to the conductor in FIG. 5. For example, in some embodiments, a machine (not shown) can apply a force (e.g., bend, push, pull, other otherwise actuate) to at least a portion of a conductor 44 to substantially form the turn portion 46 and the two leg portions 48 of a single conductor 44. In some embodiments, at least a portion of the conductors 44 can be configured into a desired shape after coupling of the first insulation 50 to the conductors 44. Although, in some embodiments, at least a portion of the conductors 44 can be configured (e.g., bent, pushed, pulled, etc.) into a desired shape (e.g., a hairpin) and then the first insulation 50 can be coupled to the conductors 44.

In some embodiments, the stator assembly 26 can comprise at least one slot member 52. In some embodiments, the stator assembly 26 can comprise at least one slot member 52 disposed in one or more of the slots 42. For example, one or more slot members 52 can be disposed in some or all of the slots 42. In some embodiments, each slot 42 can comprise at least one slot member 52. In some embodiments, at least a portion of the slot members 52 can comprise a substantially cylindrical shape. In some embodiments, the slot members 52 can comprise other shapes, such as square, rectangular, hemispherical, regular or irregular polygonal, etc. In some embodiments, at least a portion of the slot members 52 can comprise any shape desired and/or needed by the manufacturer or user. Moreover, in some embodiments, the slot members 52 can be configured and arranged to receive at least a portion of one or more conductors 44, as described in further detail below.

In some embodiments, the slot member 52 can comprise materials that can resist abrasion, can provide electrical and/or mechanical insulation, can comprise thermally-conductive properties, and/or can comprise other properties desired by a manufacturer or user. For example, in some embodiments, at least a portion of the slot members 52 can comprise materials such as polyimides (e.g., Kapton®), polyamides, polyester, polyamideimide, polyethylene terephthalate film (e.g., Mylar®), para-aramid (e.g., Kevlar®), meta-aramid (e.g., Nomex®) or other materials. In some embodiments, the slot member 52 can comprise a composite of some or all of the previously mentioned materials, such as a Nomex®-Katpton® composite.

In some embodiments, as shown in FIG. 3, at least a portion of the conductors 44 can be positioned within the slots 42. For example, in some embodiments, the stator core 34 can be configured so that the plurality of slots 42 are substantially or completely axially arranged. In some embodiments, the leg portions 48 can be inserted into the slots 42 so that at least some of the leg portions 48 can axially extend through the stator core 34. In some embodiments, the leg portions 48 can be inserted into neighboring slots 42. For example, in some embodiments, the leg portions 48 of a conductor 44 can be disposed in slots that are distanced approximately one magnetic-pole pitch apart (e.g., six slots, eight slots, etc.). In some embodiments, a plurality of conductors 44 can be disposed in the stator core 34 so that at least some of the turn portions 46 of the conductors 44 axially extend from the stator core 34 at an insertion end 56 of the stator assembly 26 and at least some of the leg portions 48 axially extend from the stator assembly 26 at a weld end 58 of the stator core 34. In some embodiments, at least a portion of the conductor 44 regions that axially extend from the stator assembly 26 at the ends 56, 58 can comprise stator end turns 54.

In some embodiments, one or more slot members 52 can be disposed within some or all of the slots 42 during assembly of the module 10. In some embodiments, the slot members 52 can be disposed within the slots 42 prior to one or more of the conductors 44 being disposed within the stator core 34. For example, in some embodiments, the slot members 52 can be positioned within the slots 42 so that at least a portion of some of the conductors 44 (e.g., the leg portions 48) can be at least partially disposed within the slot members 52. By way of example only, in some embodiments, one or more slot members 52 can be disposed within each of the slots 42 so that the slot members 52 can receive at least a portion of each of the conductors 44.

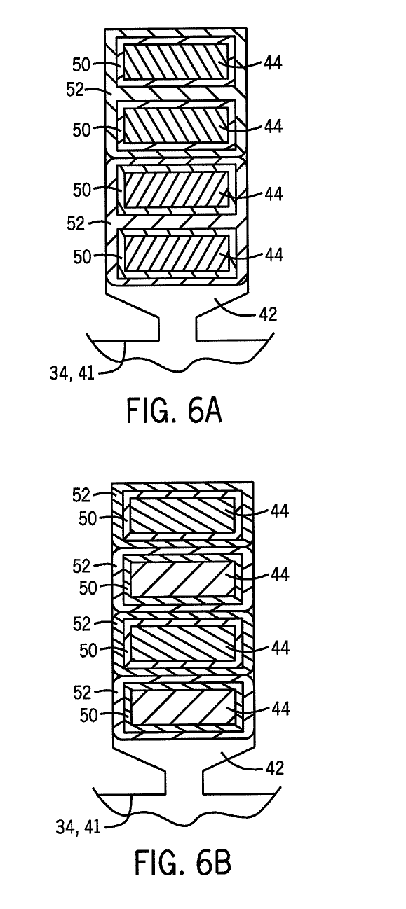

Moreover, in some embodiments, one slot member 52 can receive one or more conductors. In some embodiments, one slot member 52 can be configured and dimensioned to receive two or more conductors 44. For example, in some embodiments, at least a portion of the slot members 52 can be configured and arranged to receive portions of two conductors 44 (e.g., a leg portion 48 of two different conductors 44 or both leg portions 48 of the same conductor 44), as shown in FIG. 6A. As a result, in some embodiments, at least a portion of the slots 42 can comprise four conductors 44 and two slot members 52 (e.g., portions of two conductors 44 disposed in a slot member 52). In some embodiments, at least a portion of the slots 42 can comprise the same number of slot members 52 as conductors 44. For example, in a slot 42 including portions of four conductors 44, the slot 42 can comprise four or more slot members 52, as shown in FIG. 6B. Furthermore, in some embodiments, the stator assembly 26 can comprise any combination of any of the foregoing slot member 52/conductor 44 ratios. For example, some slots 42 can comprise four slot members 52 and four conductors 44, some slots 42 can comprise two slot members 52 and four conductors 44, and some slots can comprise one or more than one slot members 52 and four conductors 44. As previously mentioned, the use of four conductors 44 is exemplary and other number of conductors 44 (e.g., one, two, six, eight, etc.) can be disposed within the slots 42.

In some embodiments, at least some of the leg portions 48 can comprise multiple regions. In some embodiments, the leg portions 48 can comprise in-slot portions 60, angled portions 62, and connection portions 64. In some embodiments, as previously mentioned, the leg portions 48 can be disposed in the slots 42 and some regions of the leg portions 48 (e.g., the in-slot portions 60) can be at least partially received within the slot members 52. Moreover, the leg portions 48 can axially extend from the insertion end 56 to the weld end 58. In some embodiments, after insertion, at least a portion of the leg portions 48 positioned within the stator core 34 can comprise the in-slot portions 60.

In some embodiments, at least some regions of the leg portions 48 extending from stator assembly 26 at the weld and insertion ends 56, 58 can comprise the angled portions 62 and the connection portions 64. In some embodiments, after inserting the conductors 44 into the stator core 34, the leg portions 48 extending from the stator core 34 can undergo a conventional twisting process (not shown) which can lead to the creation of the angled portions 62 and the connection portions 64. For example, in some embodiments, the twisting process can locate the angled portions 62 at a more axially inward position and the connection portions 64 at a more axially outward position, as shown in FIG. 3. In some embodiments, the angled portions 62 can comprise other configurations, such as bent, curved, or otherwise removed from a horizontal axis of the conductors 44.

In some embodiments, after the twisting process, the connection portions 64 of at least a portion of the conductors 44 can be immediately adjacent to connection portions 64 of other conductors 44. As a result, the connection portions 64 can be coupled together to form one or more coupled conductor regions 63 (e.g., a portion of conductors 44 at an axially outer portion of the conductors 44 at the weld end 58). For example, in some embodiments, two generally radially adjacent connection portions 64 can be coupled together to form a coupled conductor region 63 (i.e., a portion of two conductors 44 that have been coupled together to form a portion of the stator winding 36). Moreover, in some embodiments, at least some of the slots 42 can comprise four leg portions 48, as previously mentioned. After the conventional twisting process, the four leg portions 48 can comprise four connection portions 64 that can be coupled together to define at least two coupled conductor regions 63 per slot 42.

In some embodiments, the connection portions 64 can be coupled via welding, brazing, soldering, melting, adhesives, or other coupling methods to form the coupled conductor regions 63. Additionally, in some embodiments, at least a portion of the first insulation 50 can be substantially removed at the connection portions 64 in order to enable the coupling process (i.e., formation of the coupled conductor regions 63). Although, in some embodiments, the first insulation 50 can be coupled to the conductors 44 so that it does not coat and/or cover the connection portions 64. In some embodiments, each slot 42 can comprise at least two sets of connection portions 64 that have been coupled together and circumferentially arranged (i.e., four connection portions 64 that have been coupled together to form two coupled conductor regions 63).

In some embodiments, the first insulation 50 can at least partially wear down as a result of the twisting process. For example, in some embodiments, pressure points created by the twisting process can create areas of the first insulation 50 that receive more mechanical stress relative to other portions of the first insulation 50. Over the course of the life of the module 10, the first insulation 50 can wear, and, under some circumstances, the first insulation 50 can eventually become compromised. As a result of wear of the first insulation 50, in some embodiments, bare conductors 44 (e.g., bare copper or bare copper-containing materials) can contact each other, the stator core 34, the housing 12, or other elements, which can lead to malfunctioning of the module 10 (e.g., short circuit events, grounding events, etc.).

Furthermore, in some embodiments, module 10 operations can be improved if an axial length of the stator end turns 54 is minimized so that the overall size of the electric machine module 10 can be reduced. For example, in some embodiments, the leg portions 48 can be twisted to a greater extent (e.g. the connection portions 64 and the coupled conductor regions 63 can be moved a greater circumferential distance and axially inward) so that the angled regions 62 can be disposed closer to the stator core 34 (e.g., the angled regions 62 can be disposed at a greater angle relative to a horizontal axis of the stator core 34) relative to other embodiments. As a result, the axial length of the stator assembly 26 can comprise a lesser length relative to some embodiments where the leg portions 48 are twisted to a lesser extent. In some embodiments, as a result of increasing the extent of twisting and disposing the angled regions 62 closer to the stator core 34, portions of the conductors 44 can be positioned substantially adjacent to each other (e.g., touching or almost touching each other). As a result, over the life of the module 10, the conductors 44 can contact each other, which can lead to wearing of the first insulation 50, resulting in short circuits, grounding events, and other malfunctions and/or failures of the module 10.

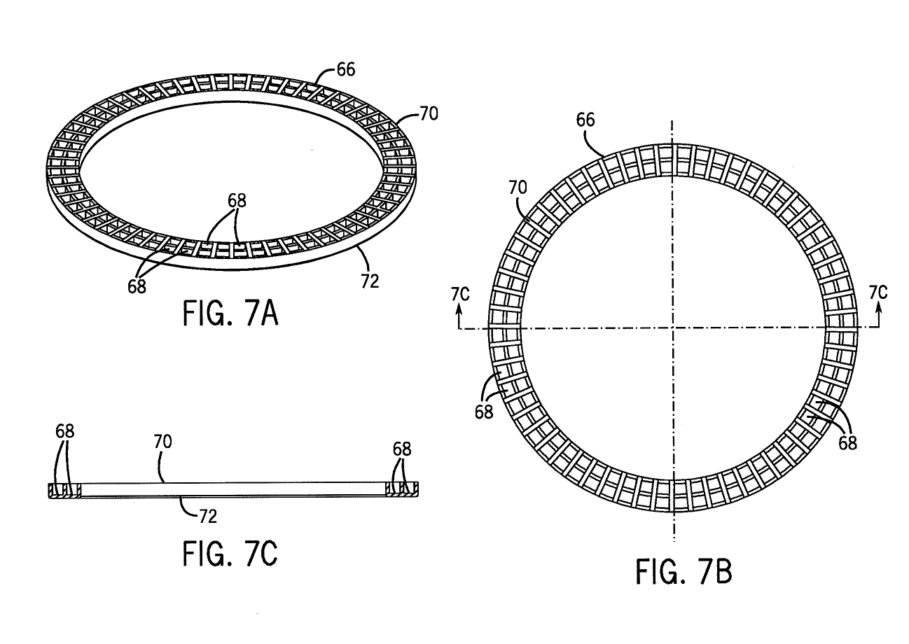

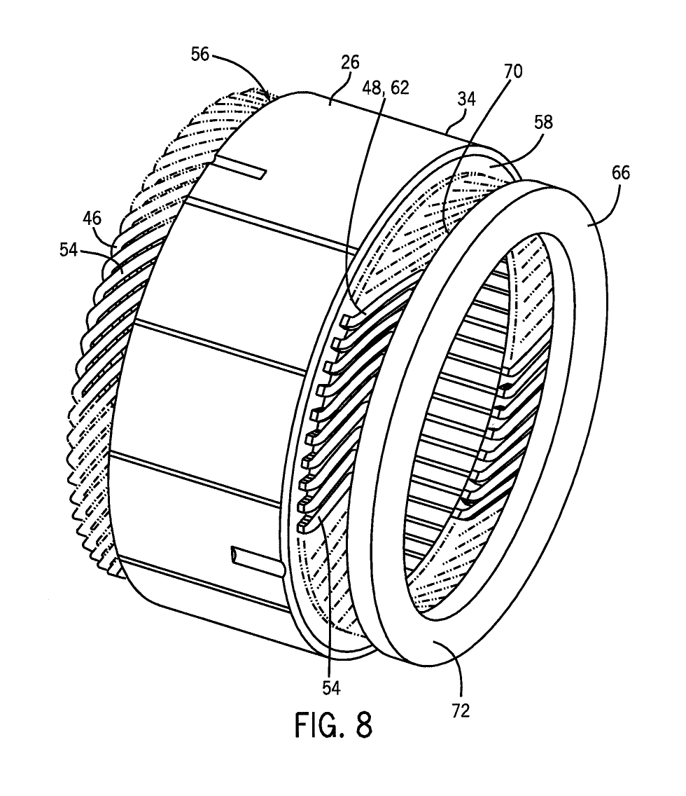

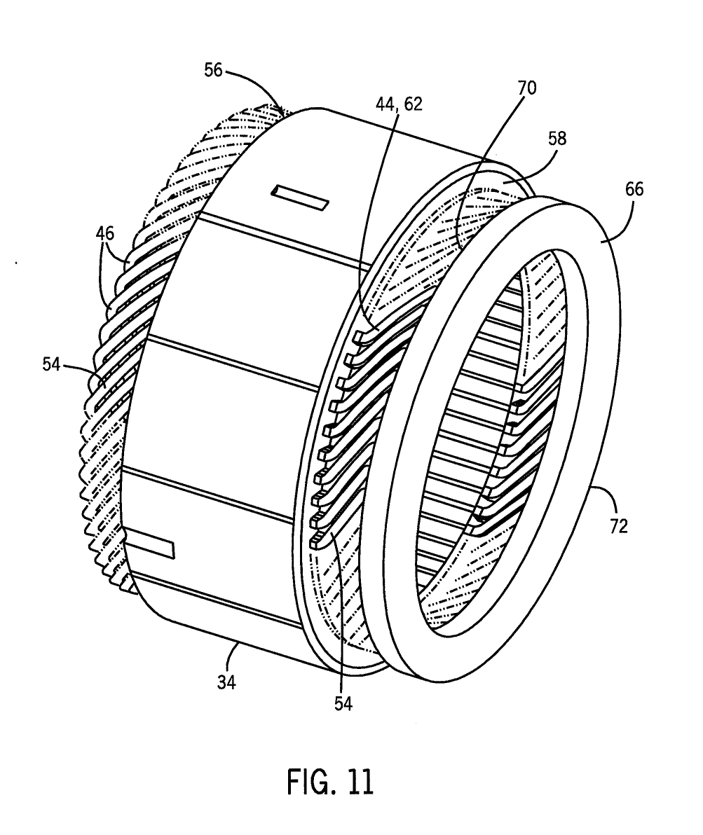

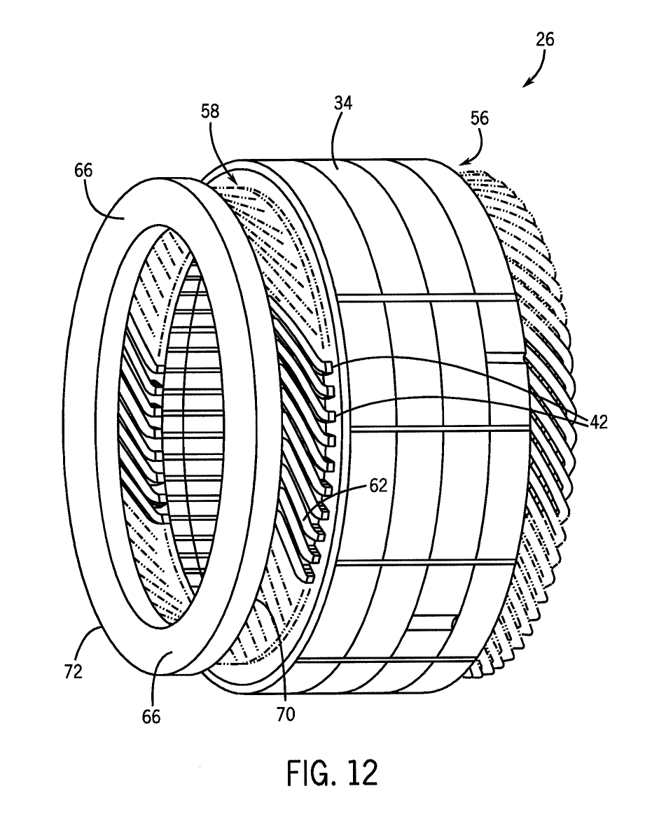

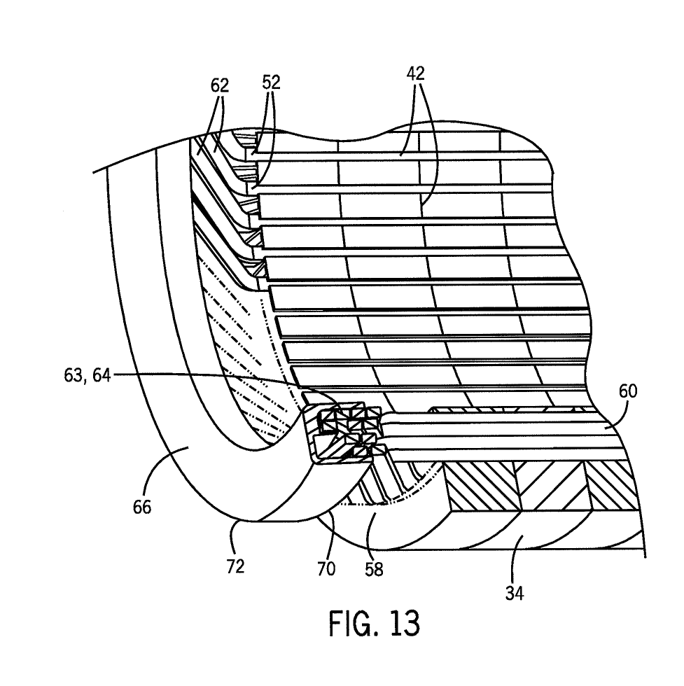

In some embodiments, at least some portions of the electric machine module 10 (e.g., the stator assembly 26) can comprise at least one insulation member 66, as shown in FIGS. 8-13. For example, in some embodiments, the insulation member 66 can be positioned over and/or coupled to portions of the stator winding 36 on at least one of the insertion end 56 and the weld end 58. In some embodiments, the insulation member 66 can be configured and arranged to insulate portions of at least some of the conductors 44 that extend from the stator core 34 at the weld end 58 of the stator assembly 26. For example, in some embodiments, the insulation member 66 can comprise a substantially annular structure (e.g., the insulation member 66 can be configured to comprise a substantially similar configuration as the general configuration of the stator assembly 26), as shown in FIGS. 7-13. In other embodiments, the insulation member 66 can comprise other shapes, such as rectangular, square, regular or irregular polygonal, etc.

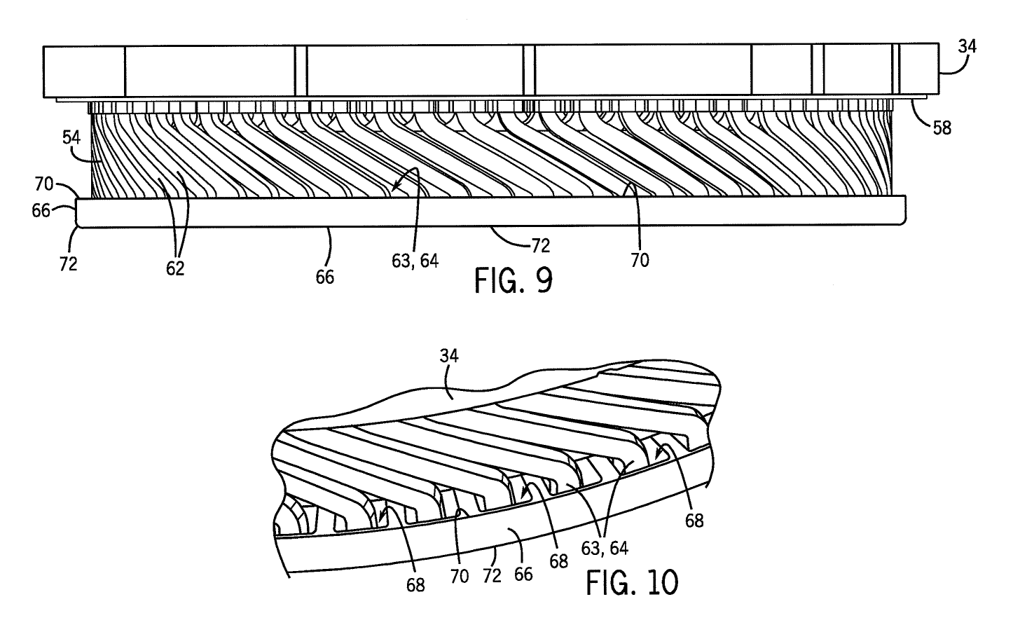

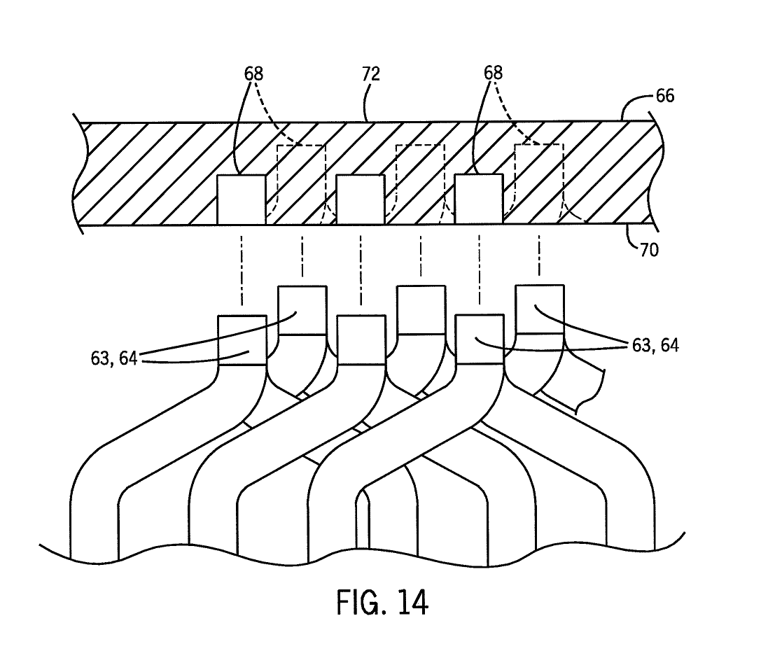

Additionally, in some embodiments, the insulation member 66 can comprise a plurality of recesses 68, as shown in FIGS. 7A-7C and 14. In some embodiments, the recesses 68 can be substantially or completely electrically and/or conductively insulated from each of the other recesses 68. The insulation member 66 can prevent the transmission of any material amounts of current between the portions of the conductors 44 (e.g., the connection portions 64 and/or the coupled conductor regions 63) disposed in adjacent recesses 68. For example, in some embodiments, the number of recesses 68 can be substantially the same as the number of coupled conductor regions 63. As shown in FIGS. 9 and 10, in some embodiments, portions of the conductors 44 can be at least partially disposed within the insulation member 66 so that a first end 70 of the insulation member 66 is substantially adjacent to at least some of the angled portions 62 of at least some of the conductors 44. Moreover, in some embodiments, a second end 72 of the insulation member 66 can be disposed substantially opposite to the first end 70 (i.e., at an axially outer portion of the stator assembly 26).

In some embodiments, as shown in FIGS. 8-13, some or all of the coupled conductor regions 63 can be positioned in the recesses 68. For example, as shown in FIGS. 8-14, in some embodiments, some portions of the conductors 44, which can include the coupled conductor regions 63, can be positioned in at least one of the recesses 68 and the insulation member 66 can extend toward the stator core 34 so that at least a portion of the any exposed conductive material of the conductors 44 (e.g., exposed because a portion of the first insulation 50 has been removed) can be substantially or completely insulated from adjacent conductors 44, the stator core 34, the housing 12, etc. As a result, in some embodiments, at least a portion of the conductors 44, including at least some portions of the coupled conductor regions 63, can be substantially insulated and/or mechanically separated from potential sources of short circuits and/or grounding events. In some embodiments, this can substantially reduce the chance of short circuit. Moreover, in some embodiments, the insulation member 66 can at least partially function to protect the coupled conductor regions 63 from other forms of damage (e.g., physical, electrical, static electrical, etc.) that may arise during electric machine module 10 operations.

In some embodiments, the insulation member 66 can comprise multiple insulation members 66. In some embodiments, each insulation member 66 can be coupled to a portion of the coupled conductor regions 63. For example, four insulation members 66 can be coupled to the coupled conductor regions 63 so that each insulation member 66 comprises about 25% of the angular span of the stator assembly 26 (i.e., about 90 degrees). In other embodiments, other numbers of insulation members 66 can be employed so that at least a portion of the coupled conductor regions 63 are positioned substantially within recesses 68 to insulate portions of the conductors 44 from other conductors 44, the housing 12, the stator core 34, etc. In some embodiments, one or more insulation member 66 subunits can be coupled together to form the insulation member 66 and then the insulation member 66 can be coupled to the stator assembly 26.

Moreover, in some embodiments, the insulation member 66 can comprise at least two substantially concentric insulation members 66 (not shown) positioned so that each of the radially adjacent and circumferentially arranged rows of coupled conductor regions 63 can be positioned substantially within the recesses 68. For example, in some embodiments, a first insulation member 66 can be coupled to the stator assembly 26 so that the coupled conductor regions 63 at in the radially inner position can be protected and/or insulated. Moreover, a second insulation member 66 can be coupled to the stator assembly 26 so that the coupled conductor regions 63 at the radially outer position can be protected and/or insulated. In some embodiments, the insulation member 66 can comprise a plurality of individual insulation members 66 that can be positioned over each of the coupled conductor regions 63 (i.e., each coupled conductor regions 63 is positioned in a single insulation member 66).

In some embodiments, the insulation member 66 can include features configured and arranged to aid in electric machine module 10 cooling and/or coolant distribution. By way of example only, in some embodiments, the housing 12 can include a coolant jacket 74 substantially circumscribing at least a portion of the electric machine 20 (e.g., the stator assembly 26), as shown in FIG. 1. In some embodiments, coolant apertures 76 can be defined through a portion of the housing 12 so that the coolant jacket 74 can be in fluid communication with the machine cavity 22. In some embodiments, a coolant can circulate through the coolant jacket 74 and enter the machine cavity 22 through the coolant apertures 76. In some embodiments, at least a portion of the coolant apertures 76 can be positioned generally radially adjacent to portions of the stator assembly 26 (e.g., the stator end turns 54) and/or the insulation member 66. In some embodiments, the insulation member 66 can be configured and arranged so that at least a portion of the coolant entering the machine cavity 22 from the coolant jacket 74 and contacting the insulation member 66 can be guided, directed, or urged toward the conductors 44 to at least partially cool them.

In some embodiments, the insulation member 66 comprise one or more materials. In some embodiments, the insulation member 66 can comprise one or more of a polymer, paper, cardboard, nylon, felt, silk, cotton, a combination thereof, and/or other suitable materials. For example, in some embodiments, the insulation member 66 can comprise an injection-molded polymer so that the entire insulation member 66, including the recesses 68, the first end 70, and the second end 72, can be manufactured at the same time in a mold. In other embodiments, as detailed in further detail below, the insulation member 66 can be manufactured from a slurry of an organic pulp and/or paper and formed using a molding process. According to some embodiments of the invention, the insulation member 66 can be used for applications not requiring electrical insulation, and as a result, the insulation member 66 can comprise conductive materials such as iron, copper, aluminum, and other conductive and/or non-conductive materials.

In some embodiments, the insulation member 66 can be coupled to portions of the conductors 44 and/or the stator assembly 26 using different coupling methods. In some embodiments, the recesses 68 can include dimensions substantially similar to the dimensions of the coupled conductor regions 63 so that the two elements can be substantially friction fit together. In some embodiments, the insulation member 66 can be conventionally “B-staged.” For example, in some embodiments, the insulation member 66 can comprise a thermally-activated adhesive. As a result, in some embodiments, after being positioned over the coupled conductor regions 63, the insulation member 66 and/or the electric machine 20 can be heated so that the adhesive can be at least partially activated and can permanently adhere to portions of the conductors 44.

In some embodiments, the insulation member 66 can be coupled to the conductors 44 in other manners. In some embodiments, after coupling the connection portions 64 and positioning the insulation member 66 over the coupled conductor regions 63, at least a portion of the module 10 can be substantially or completely coated in a second insulation (not shown). For example, in some embodiments, a varnish, a resinous material (e.g. an epoxy), another insulating material, or any combination thereof, can be applied to at least some portions of the electric machine 20 to provide an additional layer of insulation to at least partially reduce the chances of a short circuit and/or grounding events between electric machine module 10 components. In some embodiments, the second insulation can be applied by vacuum pressure impregnation, dipping, or other conventional application methods. For example, in some embodiments, the second insulation (e.g., a resin, such as epoxy, a varnish, or other insulating material) can be applied to the stator assembly 26 via vacuum pressure impregnation in a manner substantially similar to the process disclosed in U.S. patent application Ser. No. 13/233,187, which is owned by the assignee of the present application and is incorporated herein by reference in its entirety. Regardless of the manner in which the second insulation is applied, the second insulation can permeate some or all of the stator assembly 26 (e.g., the slots 42, covering the conductors 44, any insulation, etc.) and/or the insulation member 66 to couple together these two elements. As a result, in some embodiments, after curing, the second insulation can function to both insulate the conductors 44 and couple together some or all of the portions of the stator assembly 26 and the insulation member 66 (e.g., the cured varnish can be configured to permanently couple together portions of the stator assembly 26).

For example, after positioning the coupled conductor regions 63 within at least a portion of the recesses 68, a varnish can be applied to the entire stator assembly 26 to substantially seal the assembly 26 and to substantially couple together all of the elements into a substantially unitary element. Further, in some embodiments, by impregnating the insulation member 66, the varnish can at least partially enhance the structural integrity of the insulation member 66 and can substantially permanently bond together the insulation member 66 with the stator assembly 26 and/or the conductors 44. In some embodiments, the varnish can seep into some or all gaps between the recesses 68 of the insulation member 66 and the coupled conductor regions 63, which can at least partially enhance coupling between these two elements. By way of example only, in embodiments comprising a paper and/or cardboard insulation member 66, the varnish can substantially or completely saturate the insulation member 66 and once substantially cured, the insulation member 66 can be more structurally durable (i.e., relative to a non-varnish saturated insulation member 66) and can comprise a high dielectric strength between different portions of the conductors 44.

As previously mentioned, according to some embodiments of the invention, the insulation member 66 can be manufactured using different compositions. In some embodiments comprising a paper and/or cardboard insulation member 66, different compositions can be used to meet different insulation member 66 requirements. By way of example only, in some embodiments, the insulation member 66 can originate from a slurry mixture (i.e., a substantially slush-like liquid mixture). In some embodiments, after preparing the slurry mixture, it can be introduced into a press mold where the insulation member 66 can be formed to a configuration required by manufacturer and/or end user needs. As a result, in some embodiments, the insulation member 66 can comprise a press matrix insulator member 66.

In some embodiments, the slurry mixture can comprise different compositions, at least partially dependent on end user requirements. As described in further detail below, in some embodiments, the slurry mixture can comprise a base constituent, such as but not limited to ground, shredded, masticated, and/or pulverized paper. In some embodiments, the ground paper can comprise post-consumer use ground paper (i.e., recycled paper), and in other embodiments, the ground paper can comprise pre-consumer use paper. In some embodiments, water or another aqueous-based solution can be added to the ground paper to create the slurry mixture. In some embodiments, the final slurry mixture can comprise a ground paper—water mixture, so that the insulation member 66 comprises molded ground paper without significant amounts of other materials.

In some embodiments, the slurry mixture can comprise one or more additive materials. In some embodiments, the additive materials can be added to the slurry mixture to enhance different properties of the insulation member 66. For example, in some embodiments, to improve the thermal properties of the insulation member 66 (e.g., improve the ability of the insulation member 66 to receive and conduct thermal energy from the conductors 44 and/or insulate the conductors 44 from thermal energy produced by surrounding module 10 elements), materials such as Nomex® or wood fiber pulp can be added to the slurry. In some embodiments, to improve abrasion properties of the insulation member 66 (e.g., improve the ability of the insulation member 66 to resist wear during the life of the electric machine module 10), materials such as Kevlar® or wood fiber pulp can be added to the slurry mixture. In some embodiments, to improve the dielectric properties of the insulation member 66 (e.g., improve the ability of the insulation member 66 to electrically insulate the conductors 44), materials such as fiberglass (e.g., short-cut fiberglass pulp) can be added to the slurry mixture. In some embodiments, to improve the strength of the insulation member 66 (e.g., to improve the structural strength of the insulation member 66), materials such as, but not limited to, Kevlar®, Nomex®, fiberglass, silk, cotton, other organic media, or any combination thereof can be added to the slurry mixture. Moreover, any combination of any of the previously mentioned additive materials can be added to the slurry mixture to achieve desired properties of the insulation member 66.

In some embodiments, the additional materials can be added to the slurry in different proportions. By way of example only, in some embodiments, the total additive material composition of the final slurry mixture can be approximately equal to and/or less than 20% of the final mixture by mass and/or volume. In some embodiments, by keeping the additional material proportion to less than or substantially equal to 20%, the paper portion of the slurry mixture is able to substantially self-adhere. In other embodiments, other proportions of additional materials can be added as long as the additional materials are chemically and physically compatible with the other slurry mixture constituents (e.g., the additional materials can stay in solution, the additional materials do not catalyze any adverse chemical reactions between other constituents, etc.).

According to some embodiments of the invention, the insulation member 66 can be used in applications where electrical insulation is not necessarily a relevant property. By way of example only, either in addition to or in conjunction with an insulation member 66 on the weld end 58 of the stator assembly 26, in some embodiments, an insulation member 66 can be positioned over at least some of the conductors 44 at the insertion end 56 of the stator assembly 26. In some embodiments, the insertion end 56 of the stator assembly 26 does not necessarily include exposed portions of the conductors 44, and, as a result, little or no electrical insulation, beyond the first insulation 50 and the second insulation, is necessarily required. In some embodiments, the conductors 44 at the insertion end 56 may require additional electrical insulation in addition to or in lieu of the first insulation 50 and the second insulation. Accordingly, an insulation member 66 can be used to protect the conductors 44 extending from the insulation end 56 from some or all damage that can occur during electric machine 20 operation, in addition to or in lieu of insulating the conductors 44 extending from the insulation end 56. In some embodiments, because electrical insulation is not required, other constituents can be added to the slurry mixture. For example, in some embodiments, carbon fiber pulp, carbon weave, carbon nanotubes, and other suitable materials can be added even though they may include conductive properties. As a result, in some embodiments, the structural strength of the insulation member 66 can be improved and the insulation member 66 can be used to insulate the conductors 44 extending from the stator core 34 at the insertion end 56 in addition to or in lieu of insulating the conductors 44 extending from the stator core 34 at the weld end 58.

In some embodiments, other structures can be fabricated from the composition used to make the insulation member 66. For example, in some embodiments, at least one structure could be configured and arranged to be positioned along an inner diameter of the conductors 44 of the insertion end 56 and/or the weld end 58 of the stator assembly 26. Moreover, in some embodiments, other structures comprising similar constituents could be used to substantially isolate some module elements from other module 10 elements (e.g., phase leads, neutral bars, etc.). Further, in some embodiments, the structures comprising similar constituents could be used to insulate features of the module 10 such as end covers 15-17, the sleeve member 14, other portions of the housing 12, etc., to reduce the potential for a short circuit between the electric machine 20 and the housing 12.

Additionally, in some embodiments, the insulation member 66 can at least partially reduce the machine cavity 22 area occupied by the machine 20. For example, in some conventional machines, the conductors 44 should be a predetermined distance apart from an inner surface of the housing 12 to prevent short circuits. In some embodiments, by including the insulation member 66 or structures comprising similar constituents as the insulation member 66 along a portion of the inner surface of the housing 12, the space between the conductors 44 (i.e., the coupled conductor regions 63) and the housing 12 can be reduced because the reduced risk of a short circuit because of the insulation provided by the insulation member 66.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. An electric machine module comprising:
a housing at least partially defining a machine cavity;
an electric machine at least partially positioned within the machine cavity and at least partially enclosed by the housing, the electric machine including
a stator assembly including a stator core, a weld end, an insertion end, and a plurality of slots extending through the stator core from the weld end to the insertion end, and
a plurality of conductors being positioned within at least a portion of the plurality of slots, portions of the plurality of conductors extending from the weld end and the insertion end; and
an insulation member comprising a plurality of recesses being coupled to at least a portion of the conductors extending from the weld end of the stator assembly.

2. The electric machine module of claim 1, wherein at least a portion of the plurality of conductors comprise a first insulation.

3. The electric machine module of claim 2, wherein the stator assembly comprises a second insulation, wherein the second insulation secures together the insulation member and the conductors.

4. The electric machine module of claim 1, wherein the housing comprises a coolant jacket.

5. The electric machine module of claim 1, wherein the insulation member comprises a paper-containing material.

6. The electric machine module of claim 5, wherein the insulation member comprises at least one of Kevlar®, Nomex®, fiberglass, silk, and wood fiber pulp.

7. The electric machine module of claim 1, wherein the insulation member comprises an injection-molded polymer.

8. The electric machine module of claim 1, wherein at least a portion of the conductors are coupled together to form coupled conductor regions.

9. The electric machine module of claim 8, wherein the plurality of recesses are configured and arranged to receive the coupled conductor regions.

10. The electric machine module of claim 1, wherein at least a portion of the plurality of slots comprises a slot member.

11. An electric machine module comprising:
a housing including a machine cavity;
an electric machine at least partially positioned within the machine cavity, the electric machine including
a stator assembly including a stator core, a weld end, an insertion end, and a plurality of slots extending through the stator core from the weld end to the insertion end, and
a plurality of conductors being positioned within at least a portion of the plurality of slots, portions of the plurality of conductors extending from the weld end and the insertion end, each of the conductors including a turn portion extending between two leg portions, the leg portions including angled portions and connection portions extending from the weld end, and at least some of the connection portions of adjacent conductors being coupled together to form coupled conductor regions; and
an insulation member comprising a plurality of recesses, a first end, and a second end, the insulation member being positioned so that at least some of the coupled conductor regions are received within at least some of the plurality of recesses and so that the first end of the insulation member is substantially adjacent to at least some of the angled portions.

12. The electric machine module of claim 11, wherein the housing comprises a coolant jacket at least partially circumscribing a portion of the stator assembly.

13. The electric machine module of claim 12, wherein the housing comprises a plurality of coolant apertures, the stator assembly being positioned within the housing so that at least a portion of the plurality of coolant apertures are substantially adjacent to the weld end and the insertion end.

14. The electric machine module of claim 11, wherein at least a portion of the plurality of slots comprise a slot member.

15. The electric machine module of claim 11, wherein at least a portion of the plurality of conductors comprise a first insulation.

16. The electric machine module of claim 15, wherein the stator assembly comprises a second insulation, wherein the second insulation secures together the insulation member and the conductors.

17. The electric machine module of claim 11, wherein the insulation member comprises a paper-containing material.

18. The electric machine module of claim 17, wherein the insulation member comprises at least one of Kevlar®, Nomex®, fiberglass, silk, and wood fiber pulp.

19. A method of assembling a stator assembly, the method comprising:
providing a plurality of stator laminations including a plurality of teeth;
coupling together at least a portion of the plurality of stator laminations so that the plurality of teeth substantially align to form a plurality of slots and the laminations form a stator core, wherein the stator core includes an insertion end and a weld end;
inserting a plurality of conductors into the plurality of slots so that a first portion of at least some of the plurality of conductors extends from the insertion end of the stator core and a second portion of at least some of the plurality of conductors extends from the weld end of the stator core;
manufacturing an insulation member from a paper-containing material and at least one additive material so that the insulation member comprises a plurality of recesses; and
coupling the insulation member to at least some of the second portion of conductors extending from the stator core at the weld end.

20. The method of claim 19 and further comprising positioning the insulation member so that the conductors are received with at least some of the plurality of recesses.
